(19) United States
(12) Patent Application Publication
(10) Pub. No.: US 2017/0045166 A1
(43) Pub. Date: Feb. 16, 2017

(54) FLOW THROUGH FLANGE FOR A SHIP-TO-SHIP CARGO TRANSFER FLOW LINE

(71) Applicant: BP Corporation North America Inc., Naperville, IL (US)

(72) Inventor: William E. Doolittle, Spring, TX (US)

(73) Assignee: BP Corporation North America Inc., Naperville, IL (US)

(21) Appl. No.: 15/306,642

(22) PCT Filed: Apr. 27, 2015
(86) PCT No.: PCT/US2015/027777

§ 371 Date: Oct. 25, 2016

Related U.S. Application Data
(60) Provisional application No. 61/985,668, filed on Apr. 29, 2014.

(51) Int. Cl. F16L 23/00; B67D 9/00; F16L 55/07

(52) U.S. Cl. CPC F16L 23/003; F16L 55/07; B67D 9/00

(57) ABSTRACT

flange (100) for mounting to an end of a ship-to-ship cargo transfer line for transporting hydrocarbon liquids, the flange comprising: a base plate (110) including an orifice having a central axis and an outer radius; a blast plate (130) coupled to the base plate and coaxially aligned with the orifice, wherein the blast plate (130) is axially spaced from the base plate (110); wherein the blast plate (130) has an outer radius greater than or equal to the outer radius of the orifice and is configured to impede the flow of the hydrocarbon liquids from the flow line through the orifice, and wherein the blast plate (130) is configured to allow the flow of air into the flow line through orifice.

### CROSS-REFERENCE TO RELATED APPLICATIONS

This application claims the benefit of U.S. Provisional Patent Application No. 61/985,668 filed Apr. 29, 2014, which is incorporated herein by reference in its entirety.

### STATEMENT REGARDING FEDERALLY SPONSORED RESEARCH OR DEVELOPMENT

Not applicable.

### BACKGROUND

The disclosure relates generally to a flange for attaching to the terminal end of a ship-to-ship fluid transfer flow line. More particularly, the disclosure relates to a flow through flange that allows air to enter the fluid transfer line from the surrounding environment while preventing fluids within the transfer line from escaping the fluid transfer line into the surrounding environment.

Fluid cargo such as crude oil, liquefied gas (LPG), and other hydrocarbon products is often transferred between two offshore vessels positioned alongside one another via ship-to-ship (STS) cargo transfer operations. In such operations, a fluid flow line or hose extends between the receiving ship, often referred to as the daughter vessel, and the supplying ship, often referred to as the mother vessel. One end of the flow line is removably connected to an inlet of the daughter ship and the other end of the flow line is removably connected to an outlet on the mother ship. The inlet of the daughter ship is in fluid communication with the cargo tanks of the daughter ship and the outlet of the mother ship is in fluid communication with the cargo tanks of the mother ship. With the ends of the flow line securely connected to the ships, the cargo is pumped from the cargo tanks of the mother ship through the flow line into the cargo tanks of the daughter ship.

After the cargo transfer is complete, the end of the flow line connected to the outlet of the mother ship is disconnected, and then that end, now open to the surrounding environment, is lifted upward so any cargo remaining within the flow line can drain to the cargo tanks of the daughter ship. During this time, the raised end of the flow line must allow air from the surrounding environment to enter the flow line to enable drainage of the cargo. However, if the cargo storage tanks on the daughter ship are pressurized or a slug of trapped gas in the cargo storage tanks moves upward through the flow line, a small amount of the cargo (e.g., an atomized mist of hydrocarbons) may inadvertently be released from the lifted, open end of the flow line, thereby creating an undesirable pollution risk. Once the cargo in the flow line is sufficiently drained, the flow line is disconnected from the inlet of the daughter ship and can be used in another STS cargo transfer operation.

### BRIEF SUMMARY OF THE DISCLOSURE

These and other needs in the art are addressed in one embodiment by a flange for mounting to an end of a ship-to-ship cargo transfer line for transporting hydrocarbon liquids. In an embodiment, the flange comprises a base plate including an orifice having a central axis and an outer radius. In addition, the flange comprises a blast plate coupled to the base plate and coaxially aligned with the orifice. The blast plate is axially spaced from the base plate. The blast plate has an outer radius greater than or equal to the outer radius of the orifice and is configured to impede the flow of the hydrocarbon liquids from the flow line through the orifice. The blast plate is configured to allow the flow of air into the flow line through orifice.

These and other needs in the art are addressed in another embodiment by a system for draining a ship-to-ship cargo transfer line including a flexible hose and a connection flange disposed at an open end of the hose. In an embodiment, the system comprises a base plate releasably mounted to the connection flange. The base plate includes a first planar face, a second planar face, and an orifice extending from the first planar face to the second planar face. The orifice has a central axis and an outer radius. The second planar face is axially adjacent the connection flange and the first planar face is distal the connection flange. In addition, the system comprises a blast plate coupled to the second planar face of the base plate. The blast plate is coaxially aligned with the orifice and has an outer radius greater than the outer radius of the orifice. The blast plate is configured to inhibit the flow of the hydrocarbon liquids from the flow line through the orifice and allow the flow of air into the flow line through orifice. Further, the system comprises a screen mounted to the first planar face of the base plate and covering the orifice. The screen is configured to allow the flow of air into the flow line through orifice and capture the hydrocarbon liquids that flow from the flow line through the orifice.

These and other needs in the art are addressed in another embodiment by a method for draining hydrocarbon liquids in a ship-to-ship cargo transfer line including a flexible hose and a connection flange disposed at an open end of the hose. In an embodiment, the method comprises (a) connecting a flow through flange to the connection flange. The flow through flange includes a base plate including an orifice having a central axis and an outer radius and a blast plate coupled to the base plate. The blast plate is axially spaced from the base plate and extends radially across the orifice. In addition, the method comprises (b) lifting the flow through flange and the connection flange after (a). Further, the method comprises (c) allowing air to flow into the cargo transfer line through the orifice and around the blast plate, Still further, the method comprises (d) draining the hydrocarbon liquids from the cargo transfer line during (c). Moreover, the method comprises (c) inhibiting the flow of hydrocarbon liquids in the cargo transfer line through the orifice with the blast plate during (d).

Embodiments described herein comprise a combination of features and advantages intended to address various shortcomings associated with certain prior devices, systems, and methods. The foregoing has outlined rather broadly the features and technical advantages of the invention in order that the detailed description of the invention that follows may be better understood. The various characteristics described above, as well as other features, will be readily apparent to those skilled in the art upon reading the following detailed description, and by referring to the accompanying drawings. It should be appreciated by those skilled in the art that the conception and the specific embodiments disclosed may be readily utilized as a basis for modifying or designing other structures for carrying out the same purposes of the invention. It should also be realized by those skilled in the art that such equivalent constructions do not depart from the spirit and scope of the invention as set forth in the appended claims.

### BRIEF DESCRIPTION OF THE DRAWINGS

For a detailed description of the preferred embodiments of the invention, reference will now be made to the accompanying drawings in which:

FIG. 1 is a perspective view of an embodiment of a flow through flange in accordance with the principles described herein mounted to a mating flange at the open end of an STS cargo transfer line;

FIG. 2 is a perspective view of the STS cargo transfer line of FIG. 1;

FIG. 3 is a perspective front view of the flow through flange of FIG. 1;

FIG. 4 is a perspective rear view of the flow through flange of FIG. 1;

FIG. 5 is a front view of the flow through flange of FIG. 1;

FIG. 6 is a rear view of the flow through flange of FIG. 1;

FIG. 7 is a top view of the flow through flange of FIG. 1;

FIG. 8A is a cross-sectional view of the flow through flange of FIG. 1 with the blast plate in the open position;

FIG. 8B is a cross-sectional view of the flow through flange of FIG. 1 with the blast plate in the closed position;

FIG. 9 is an exploded cross-sectional view of the flow through flange of FIG. 1;

FIGS. 10A-10F are schematic perspective views illustrating an embodiment of a method for draining a ship-to-ship fluid transfer line using the flow through flange of FIG. 1;

FIG. 11 is a perspective view of an embodiment of a flow through flange in accordance with the principles described herein mounted to a mating flange at the open end of an STS cargo transfer line and

FIGS. 12A and 12B are perspective views of the connection pins of the flow through flange of FIG. 11.

### DETAILED DESCRIPTION OF THE PREFERRED EMBODIMENTS

The following discussion is directed to various exemplary embodiments. However, one skilled in the art will understand that the examples disclosed herein have broad application, and that the discussion of any embodiment is meant only to be exemplary of that embodiment, and not intended to suggest that the scope of the disclosure, including the claims, is limited to that embodiment.

Certain terms are used throughout the following description and claims to refer to particular features or components. As one skilled in the art will appreciate, different persons may refer to the same feature or component by different names. This document does not intend to distinguish between components or features that differ in name but not function. The drawing figures are not necessarily to scale. Certain features and components herein may be shown exaggerated in scale or in somewhat schematic form and some details of conventional elements may not be shown in interest of clarity and conciseness.

In the following discussion and in the claims, the terms “including” and “comprising” are used in an open-ended fashion, and thus should be interpreted to mean “including, but not limited to . . . .” Also, the term “couple” or “couples” is intended to mean either an indirect or direct connection. Thus, if a first device couples to a second device, that connection may be through a direct connection, or through an indirect connection via other devices, components, and connections. In addition, as used herein, the terms “axial” and “axially” generally mean along or parallel to a central axis (e.g., central axis of a body or a port), while the terms “radial” and “radially” generally mean perpendicular to the central axis. For instance, an axial distance refers to a distance measured along or parallel to the central axis, and a radial distance means a distance measured perpendicular to the central axis. Any reference to up or down in the description and the claims will be made for purposes of clarity, with “up”, “upper”, “upwardly” or “upstream” meaning toward the surface of the borehole and with “down”, “lower”, “downwardly” or “downstream” meaning toward the terminal end of the borehole, regardless of the borehole orientation.

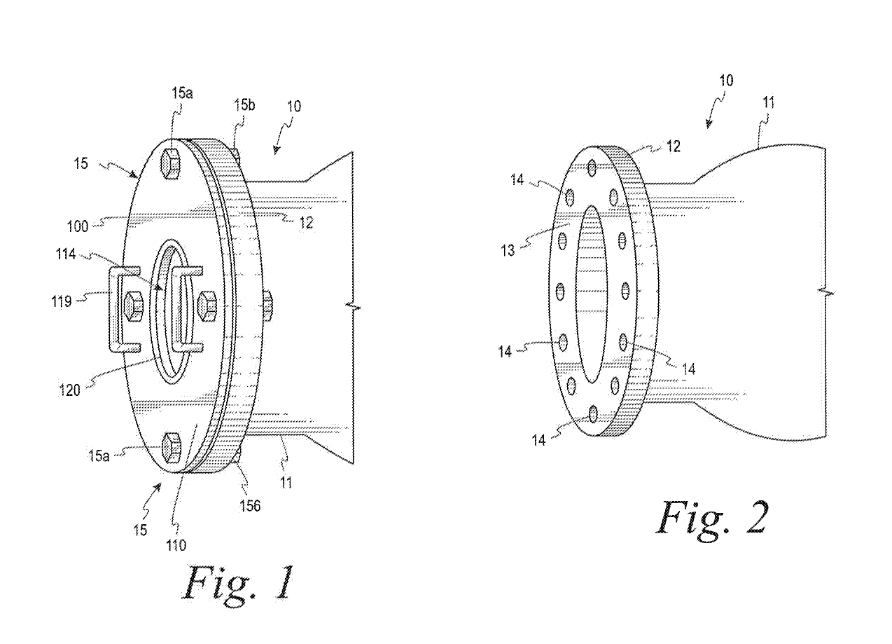

Referring now to FIG. 1, an embodiment of a flow through flange 100 is shown removably attached to an STS cargo transfer line 10. As will be described in more detail below, following cargo transfer operations, flange 100 is secured to transfer line 10 and allows air to enter transfer line 10 from the surrounding environment to facilitate draining of line 10, while simultaneously inhibiting and/or preventing liquids from escaping transfer line 10 into the surrounding environment. As best shown in FIG. 2, transfer line 10 includes a flexible rubber conduit or hose 11 and a rigid, annular connection flange 12 disposed at the open end of hose 11, The opposite end of hose (not shown) also includes a rigid, annular connection flange removably connected to a mating connection flange on an inlet line of the daughter ship. Connection flange 12 has a planar face 13 distal hose 11 and a plurality of uniformly circumferentially-spaced throughbores 14 for connecting transfer line 10 to flange 100, as well as other flanges (e.g., the mating connection flange on an outlet of a mother ship). Flange 100 is removably mounted to connection flange 12 with a plurality of fasteners 15. In this embodiment, each fastener 15 includes a bolt 15a and a nut 15b threaded onto the bolt 15a. Bolts 15a extend through flange 100 and bores 14, and nuts 15b are threaded onto bolts 15a, thereby squeezing flow through flange 100 against face 13 of connection flange 12. For most STS cargo transfer lines (e.g., transfer line 10), the flexible hose (e.g., hose 11) has a diameter between 3.0 in. and 16.0 in., and the connection flange (e.g., connection flange 12) has an outer diameter greater than the flexible hose. Thus, embodiments of flange 100 described herein are particularly suited for 3.0 in. to 16.0 in. cargo transfer lines.

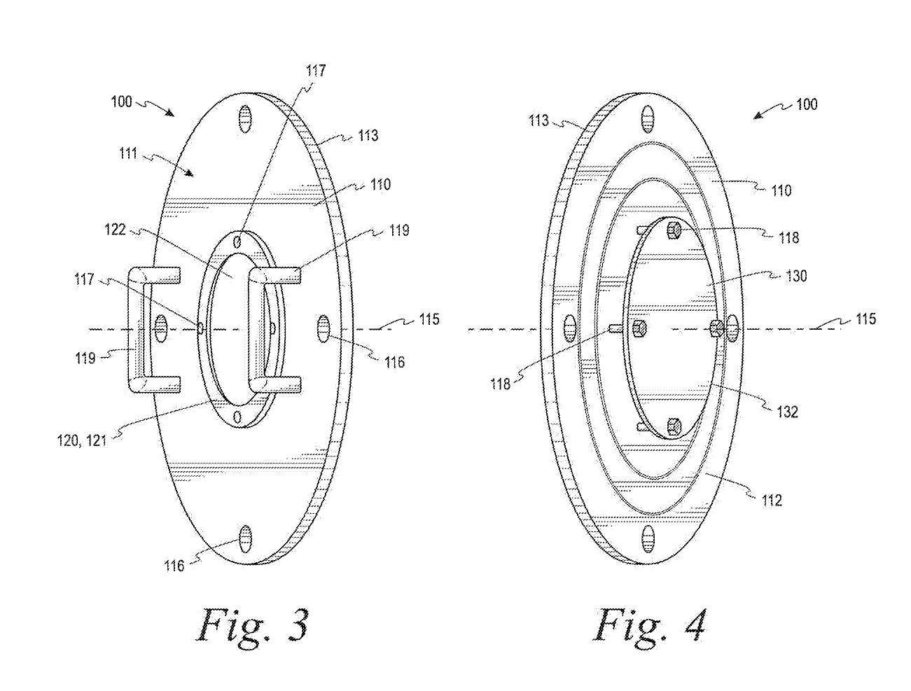

Referring now to FIGS. 3-9, in this embodiment, flange 100 includes a base plate 110, a screen 120 fixably attached to base plate 130, and a blast plate 130 moveably coupled to base plate 110, Base plate 110 is a rigid circular plate having a first planar face 111, a second planar face 112 oriented parallel to face 111, a radially outer edge or surface 113 extending between faces 111, 112, and an orifice or throughbore 114 extending between faces 111, 112. In addition, base plate 110 has a central axis 115 that passes through the center of plate 110 perpendicular to faces 111, 112. Orifice 114 is centered on plate 110, and thus, share the same central axis 115 with plate 110.

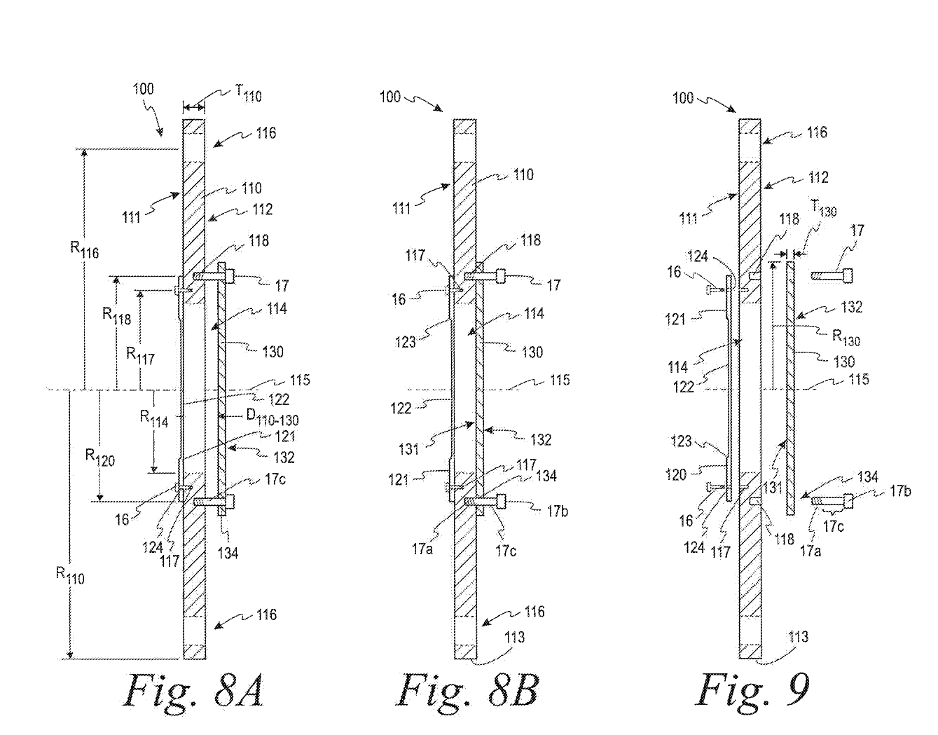

Referring now to FIGS. 8A, 8B, and 9, plate 110 has a thickness T₁₁₀ measured axially between faces 111, 112 and an outer radius R₁₁₀ measured radially from axis 115 to outer edge 113. In general, radius R₁₁₀ and thickness T₁₁₀ can be varied depending on a variety of factors including, without limitation, diameter of connection flange 12, the desired weight of base plate 110 and flange 100, etc. As previously described, for most STS cargo transfer lines (e.g., transfer line 10), the flexible hose (e.g., hose 11) has a diameter between 3.0 in. and 16.0 in., and thus, radius R₁₁₀ will typically be greater than 3.5 in. to ensure proper mating of base plate 110 and the connection flange of the STS cargo transfer line. Further, in embodiments described herein, flange 100 preferably has a weight that allows it to be manually lifted, manipulated, and positioned by vessel personnel, and thus, thickness T₁₁₀ is preferably between 0.25 in. and 1.5 in. The embodiment of flange 100 shown in FIGS. 3-9, base plate 110 has a radius R₁₁₀ of 9.50 in. and a thickness T₁₁₀ of ⅝ in., which allows base plate 110 to mate with the connection flange of an STS cargo transfer line with a 12.0 in, diameter flexible hose, while resulting in flange 100 having a weight sufficiently low that it can be manually lifted, manipulated, and positioned by vessel personnel. In this embodiment, base plate 110 is dimensioned to be compatible with a conventional ANSI 150# flange, but has a lower weight than a conventional ANSI 150# flange having the same outer radius R₁₁₀ as thickness T₁₁₀ of base plate 110 is less than the thickness of a conventional ANSI 150# flange having the same outer radius R₁₁₀.

Orifice 114 has a radius R₁₁₄ that is preferably between 1.0 in. and 4.0 in. The radius R₁₁₄ of orifice 114 preferably increases as outer radius R₁₁₀ of base plate 110 and the diameter of the corresponding flow line 10 increases. In this embodiment, radius R₁₁₄ is 3 in.

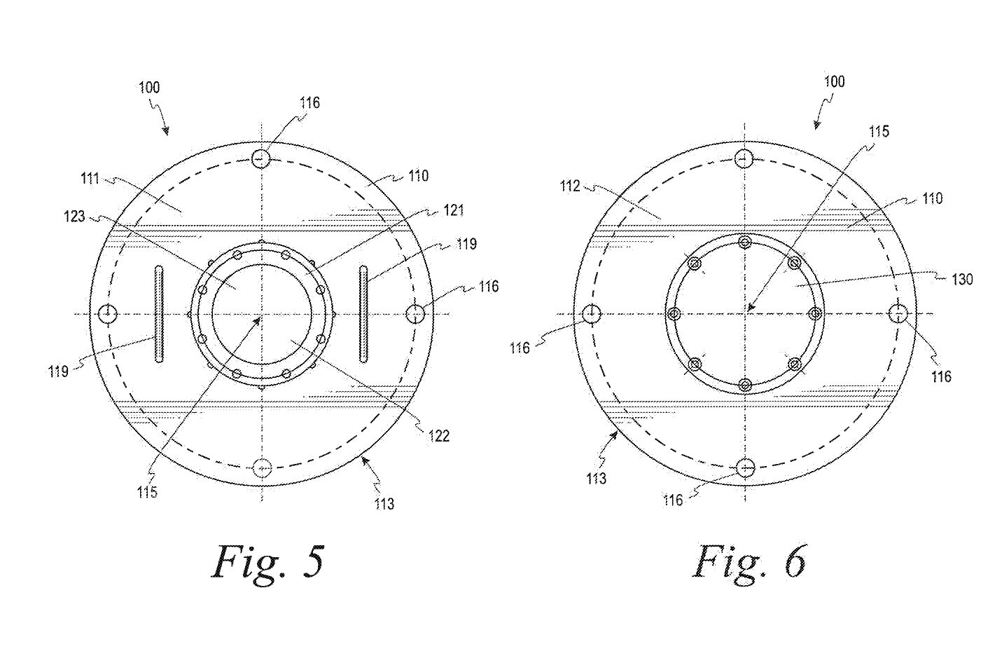

Referring now to FIGS. 5, 6, 8A, 8B, and 9, base plate 110 also includes a plurality of uniformly circumferentially-spaced throughbores 116 disposed about the outer periphery of plate 110 proximal outer edge 113, a plurality of uniformly circumferentially-spaced counterbores 117 disposed about orifice 114, and a plurality of uniformly circumferentially-spaced counterbores 118 disposed about orifice 114. Throughbores 116 extend axially between faces 111, 112, counterbores 117 extend axially from face 111 (but do not extend to face 112), and counterbores 118 extend axially from face 112 (but do not extend to face 111). Throughbores 116 are radially positioned proximal the outer periphery of base plate 110, whereas counterbores 117, 118 are radially positioned inward of throughbores 116 and proximal orifice 114. It should be appreciated that counterbores 117, 118 are radially spaced-apart so as not to intersect or interfere with each other. More specifically, as best shown in FIG. 8A, each throughbore 116 is disposed at the same radius R₁₁₆, each counterbore 117 is disposed at the same radius R₁₁₇ that is less than radius R₁₁₆, and each counterbore 118 is disposed at the same radius R₁₁₈ that is between radii R₁₁₆, R₁₁₇. In this embodiment, radius R₁₁₆ is 8.5 in,, which allows alignment of throughbores 116 of base plate 110 with throughbores 14 of connection flange 12, radius R₁₁₇ is 3.75 in., and radius R₁₁₈ is 4 in. As will be described in more detail below, in this embodiment, throughbores 116 receive fasteners 15, which removably secure plate 110 to connection flange 12 (FIG. 1), counterbores 117 are internally threaded for receiving externally threaded bolts 16 that secure screen 120 to base plate 110, and counterbores 118 are internally threaded for receiving externally threaded bolts 17 that moveably couple blast plate 130 to base plate 110. It should be appreciated that base plate 110 includes fewer throughbores 116 than throughbores 14 in connection flange 12. In this embodiment, base plate 110 includes only four uniformly-circumferentially-spaced throughbores 116.

Referring now to FIGS. 1, 3, 5, and 7, a pair of handles 119 are fixably attached to base plate 110 and extend axially from face 111. Handles 119 provide a convenient means for ship personnel to lift, maneuver, and position flange 100. In this embodiment, handles 119 are generally U-shaped, however, in other embodiments, handles 119 have different geometries.

Handles 119 are radially positioned to contact and interfere with connection flange 12 of STS cargo transfer line 10 if ship personnel attempt to attach flange 100 to connection flange 12 in the wrong orientation. More specifically, as best shown in FIG. 1, flange 100 is specifically designed to be secured to connection flange 12 with face 112 engaging face 13, otherwise, flange 100 may not function properly. However, positioning handles 119 along face 111 such that handles 119 at least partially radially overlap with connection flange 12 when bores 116, 14 are coaxially aligned ensures handles 119 will interfere with connection flange 12, thereby preventing flange 100 from being mounted to connection flange 12 in the incorrect orientation. For example, in this embodiment, handles 119 extend to a radius that is greater than the inner radius of connection flange 12 such that handles 119 will axially abut connection flange 12 when base plate 110 is coaxially aligned with connection flange 12 and axially urged toward connection flange 12 with face 111 facing connection flange 12 (i.e., with face 112 facing away from connection flange 12).

Referring now to FIGS. 3, 5, 8A, 8B, and 9, screen 120 includes an outer support frame 121 and an inner mesh 122 mounted to frame 121. Frame 121 is an annular plate having a central opening or window 123. In addition, frame 121 includes a plurality of uniformly circumferentially-spaced mounting holes 124, which facilitate mounting of screen 120 to base plate 110. An equal number of holes 124 and counterbores 117 are provided, and further, the radial positioning and circumferential spacing of holes 124 and counterbores 117 are the same such that holes 124 and counterbores 117 can coaxially aligned when screen 120 is centered on face 111 of base plate 110 and coaxially aligned with orifice 114, Thus, each hole 124 is disposed at the same radius R₁₁₇ as counterbores 117. Mesh 122 extends across and completely covers window 123. In embodiments described herein, the individual openings in mesh 122 preferably have a size between 20 micron and 60 micron, which generally allow gases to pass therethrough but block and impede the flow of atomized liquids therethrough. In this embodiment, the openings in mesh 122 have a size of 40 micron.

Screen 120 is radially centered along face 111 and coaxially aligned with orifice 114 with each hole 124 coaxially aligned with a corresponding counterbore 117 in base plate 110. Screen 120 is fixably attached to base plate 110 with bolts 16, which extend through holes 124 and threadably engage the corresponding counterbores 117. Bolts 16 and counterbores 117 are sized such that frame 121 is compressed against face 111 of base plate as bolts 16 are tightened. Screen 120 has an outer radius R₁₂₀ greater than radius R₁₁₄ of orifice 114, and thus, when screen 120 is secured to base plate 110, it extends radially beyond orifice 114, thereby completely covering orifice 114. In this embodiment, radius R₁₂₀ is 4.0 in.

In this embodiment, one screen 120 is shown mounted to blast plate 110. However, in other embodiments, multiple screens 120 are mounted to blast plate 110. In such embodiments, multiple screens 120 are stacked together and coaxially aligned with orifice 114. In addition, each hole 124 in each screen 120 is coaxially aligned with a corresponding counterbore 117 in base plate 110, and one bolt 16 extends through each set of aligned holes 124 and is threaded into the corresponding counterbore 117, thereby compressing the stack of screens 120 together against blast plate 110. When multiple screens 120 are employed, the openings in each mesh 122 can be the same or different, but are preferably between 20 micron and 60 micron.

Referring now to FIGS. 4 and 6-9, blast plate 130 is a rigid circular plate having parallel planar faces 131, 132 facing away from each other, an outer radius R₁₃₀ (FIG. 9), and a thickness T₁₃₀ (FIG. 9) measured between faces 131, 132. Radius R₁₃₀ is greater than radius R₃₁₄ of orifice 114, and further, thickness T₁₃₀ is preferably between ⅛in. and 0.5 in. In this embodiment, radius R₁₃₀ is 4.5 in. and thickness T₁₃₀ is ¼ in. In addition, as best shown in FIGS. 8A, 8B, and 9, blast plate 130 includes a plurality of uniformly circumferentially-spaced holes 134 radially positioned proximal the radially outer periphery of plate 130, which facilitate coupling of blast plate 130 to base plate 110. An equal number of holes 134 and counterbores 118 are provided, and further, the radial positioning and circumferential spacing of holes 134 and counterbores 118 are the same such that holes 134 and counterbores 118 can be placed in coaxial alignment when blast plate 130 is radially centered relative to face 112 and coaxially aligned with orifice 114. Thus, each hole 134 is disposed at the same radius R₁₁₈ as corresponding counterbores 118.

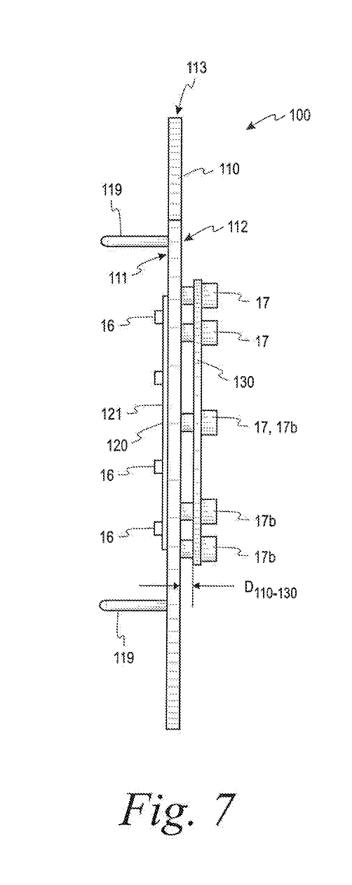

Referring now to FIGS. 8A, 8B, and 9, blast plate 130 is coupled to base plate 110 with bolts 17, which extend through holes 134 and threadably engage the corresponding counterbores 118. However, bolts 17 do not compress blast plate 130 against face 112 when bolts 17 are sufficiently tightened. Rather, blast plate 130 is free to slide axially along bolts 17. More specifically, each bolt 17 has an externally threaded tip 17a, a head 17b opposite tip 17a, and a smooth cylindrical surface 17c extending between tip 17a and head 17b. Each tip 17a is threaded into a mating counterbore 118 and cylindrical surface 17c extends from face 112 of base plate 110 through the corresponding hole 134 in blast plate 130. Surface 17c of each bolt 17 has a diameter less than the diameter of the corresponding hole 134 in blast plate 130 and a length greater than thickness T₁₃₀ of blast plate 130. Thus, blast plate 130 is free to slide axially along surfaces 17c of bolts 17 relative to base plate 110 between a first or open position axially spaced from base plate 110 and axially abutting heads 17b as shown in FIG. 8A, and a second position or closed position axially spaced from heads 17b and axially abutting face 112 of base plate 110 as shown in FIG. 8B. As best shown in FIGS. 7 and 8A, with blast plate 130 in the open axially abutting heads 17b (i.e., at the maximum spacing from base plate 110), blast plate 130 is axially spaced from base plate 110 by an axial distance D₁₁₀₋₁₃₀ that is preferably at least 0.25 in. and more preferably between 0.25 in. and 2.0 in. To reduce friction between surface 17c and blast plate 130, surface 17c of each bolt 17 preferably comprises a low friction Teflon coating. In some embodiments, an annular seal (e.g., O-ring seal) is mounted to blast plate 130 or base plate 110 such that an annular seal is formed between base plate 110 and blast plate 130 around orifice 114 when blast plate 130 is in the closed position.

In this embodiment, each hole 134 is a cylindrical bore. However, in other embodiments, each hole 134 is chamfered at its ends (i.e., where it intersects planar faces 131, 132) to facilitate the free sliding of blast plate 130 along bolts 17 even if blast plate 130 move slightly out of coaxial alignment with orifice 114.

As previously described, outer radius R₁₃₀ of blast plate 130 is greater than radius R₁₁₄ of orifice 114, and thus, when blast plate 130 is coupled to base plate 110, it extends radially beyond orifice 114. As a result, blast plate 130 impedes fluid flow through flange 100 in either axial direction by creating a tortuous flow path. Accordingly, blast plate 130 may also be referred to herein as a “flow restrictor.” This generally provides a greater hindrance to liquid flow from STS cargo transfer line 10 through flange 100 into the surrounding environment as compared to the flow of air from the surrounding environment through flange 100 into STS cargo transfer line 10.

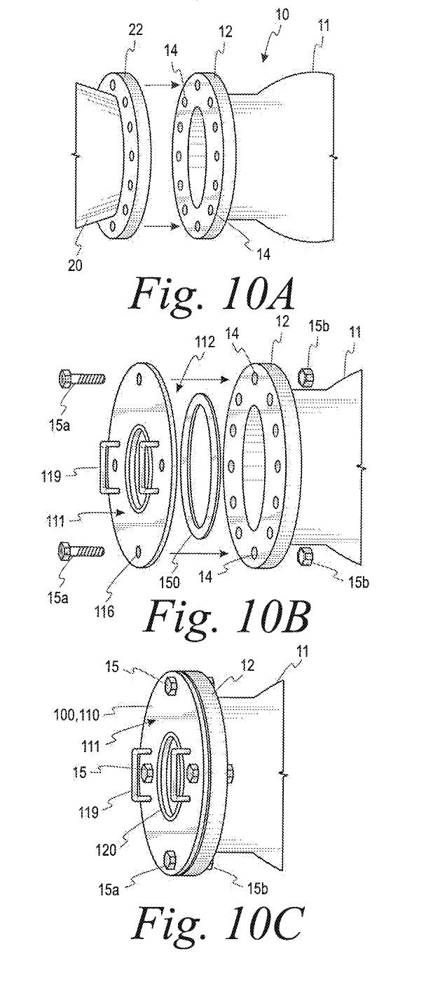

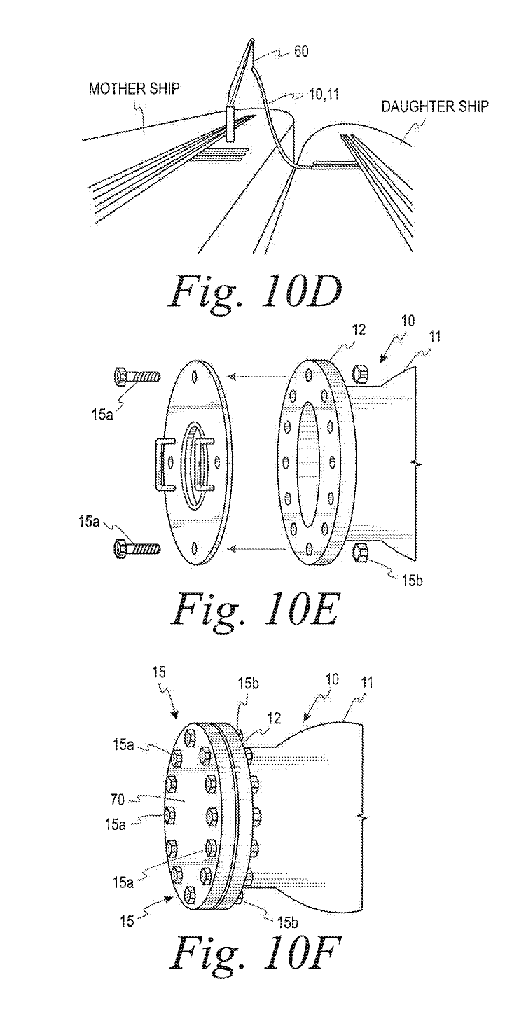

Referring now to FIGS. 10A-10F, an STS cargo transfer operation employing flange 100 previously described to facilitate the draining of STS cargo transfer line 10 is shown. As previously described STS cargo transfer line 10 extends from the daughter ship and is in fluid communication with the cargo tanks of the daughter ship. Transfer line 10 is passed to the mother ship and connection flange 12 is secured to the mating connection flange 22 of an outlet 20 of the mother ship (e.g., an outlet on a supply manifold on the mother ship). The cargo (e.g., crude oil, liquefied gas (LPG), and other hydrocarbon products) is then pumped from the mother ship through the outlet 20 and STS cargo transfer line 10 into the cargo tanks of the daughter ship. Once the cargo transfer is complete, connection flange 12 is disconnected from connection flange 22 as shown in FIG. 10A. Next, flange 100 is manually mounted to connection flange 12 as shown in FIGS. 10B and 10C. More specifically, flange 100 is lifted with handles 119 by vessel personnel and oriented with face 112 facing connection flange 12 (and face 111 facing away from flange 12). Then, vessel personnel utilize handles 119 to align base plate 110 with connection flange 12, move base plate 110 towards connection flange 12 to bring face 112 toward connection flange 12, and rotate flange 100 as necessary to align each throughbore 116 of base plate 110 with one bore 14 of connection flange 12. A bolt 15a is then advanced through each throughbore 116 and corresponding bore 14 and a nut 15b is threaded onto each bolt 15a and tightened to pull base plate 110 and connection flange 12 together. In this embodiment, an annular gasket 150 is positioned between face 112 and connection flange 12. Gasket 150 is compressed between base plate 110 and connection flange 12 as they are pulled together. The nuts are preferably tightened until they are snug, but not over-torqued. Therefore, power tools such as pneumatic wrenches are preferably not employed to tighten the nuts 15b to bolts 15a.

Moving now to FIG. 10D, with flow through flange 100 mounted to connection flange 12 of STS cargo transfer line 10, the end of line 10 is lifted to allow any cargo within line 10 to drain under gravity into the storage tanks of the daughter ship. In this embodiment, a strap 60 is placed around hose ii proximal connection flange 12 and used to lift the end of line 10. However, in other embodiments, one or both handles 119 can be employed to lift the end of line 10 (e.g., a strap 60, hook or other device can be connected to handle 119 and used to lift the end of line 10).

Referring still to 10D, with flange 100 mounted to connection flange 12 in the desired orientation (i.e., with face 112 facing connection flange 12) and the end of STS cargo transfer line 10 lifted to place line 10 in a substantially vertical orientation, blast plate 130 transitions to the open position (FIGS. 4, 7, and 8A) as blast plate 130 will slide downward along bolts 17 away from base plate 110 under gravity. With blast plate 130 in the open position, air is allowed to pass from the surrounding, environment axially through mesh 122 of screen 120 and orifice 114, radially outward between base plate 110 and blast plate 130, and then around the radially outer periphery of blast plate 130 into hose 11, thereby enabling the drainage of cargo in transfer line 10 into the cargo tanks of the daughter ship. Further, with blast plate 130 in the open position, any splash of cargo or atomized mist of cargo within transfer line 10 is inhibited and/or prevented from exiting transfer line 10 through flange 100 by blast plate 130 and screen 120. More specifically, blast plate 130 blocks and impedes the axial flow of fluids from transfer line 10 through orifice 114 since blast plate 130 extends radially beyond the periphery of orifice 114. In other words, inclusion of blast plate 130 results in a more tortuous flow path from transfer line 10 through flange 100, which generally inhibits the flow of liquids and atomized mists through flange 100. Further, any liquid or atomized mist in transfer line 10 that travels around blast plate 114 and radially inward toward orifice 114 is generally blocked and caught by the relatively fine mesh 122, thereby inhibited and/or prevented any such liquid or atomized mist from passing through flange 100 to the surrounding environment. In the manner described, flow through flange 100 allows air to enter STS cargo transfer line 10 to allow drainage of cargo within line 10 while simultaneously inhibiting and/or preventing atomized mists of liquid cargo and relatively small volumes of liquid cargo from passing through flange 100 into the surrounding environment.

Still further, if a sufficiently large volume or slug of cargo within transfer line 10 is pushed upward within flow line 10 to flange 100 (e.g., if trapped air within the cargo tanks escapes or cargo tanks are pressurized), such cargo will initially impact blast plate 130, which applies an axially upward force on blast plate 130 and transition blast plate 130 from the open position to the closed position (FIG. 8B). In the closed position, blast plate 130 engages base plate 110 and completely covers orifice 114, thereby blocking and impeding the flow of cargo into and through orifice 114. Since it may take a short period of time for blast plate 130 to transition to the closed position, and further, blast plate 130 may not form a liquid tight seal with base plate 110 in the closed position, a small amount of liquid cargo may pass radially inward between blast plate 130 and base plate 110. However, any such liquid cargo that reaches orifice 114 is generally blocked and caught by the relatively fine mesh 122, thereby inhibited and/or prevented any such liquid from passing through flange 100 to the surrounding environment. After the cargo impacts blast plate 130 and begins to drain back downward through STS cargo transfer line 10, blast plate 130 will automatically transition back to the open position under gravity. In the manner described, flow through flange 100 allows air to enter STS cargo transfer line 10 to allow drainage of cargo within line 10 while also being able to react to the backflow of relatively large volumes of liquid cargo to inhibit and/or prevent such liquid cargo from passing through flange 100 into the surrounding environment.

Moving now to FIG. 10E, once STS cargo transfer line 10 is sufficiently drained, flow through flange 100 is removed from connection flange 12. In particular, fasteners 15 are removed and vessel personnel use handles 119 to hold flange 100 and pull it away from connection flange 12. Once flow through flange 100 is removed, a cap or blind flange 70 is secured to connection flange 12 with fasteners 15 to close off the open end of STS cargo transfer line 10 as shown in FIG. 10F. The opposite end of STS cargo transfer line 10 can also be removed from the inlet of the daughter ship and capped with a blind flange (e.g., blind flange 70) such that transfer line 10 can be transported to another set of ships for STS cargo transfer operations.

Referring again to FIGS. 10A and 10B, as previously described, base plate 110 includes fewer throughbores 116 than there are bores 14 in connection flange 12. Connection flange 12 has the same number of bores 14 as mating connection flange 22, and thus, base plate 110 also has fewer throughbores 116 than there are bores in connection flange 22. This is intended to limit the use of flange 100 with STS cargo transfer line 10 only when line 10 is not coupled to connection flange 22. In particular, if flange 100 is inadvertently left mounted to connection flange 12 (e.g., following the drainage of transfer line 10), and transfer line 10 is subsequently coupled to an outlet of a mother ship to transport cargo, flange 100 would undesirably inhibit the transfer of cargo from the mother ship to the daughter ship. However, by including fewer throughbores 116 than there are bores 14 in connection flanges 12, 22, base plate 110 will block the insertion of bolts through at least some of the aligned bores 14 in connection flanges 12, 22, thereby providing an indicator to ship personnel that something is amiss and that flange 100 needs to be removed.

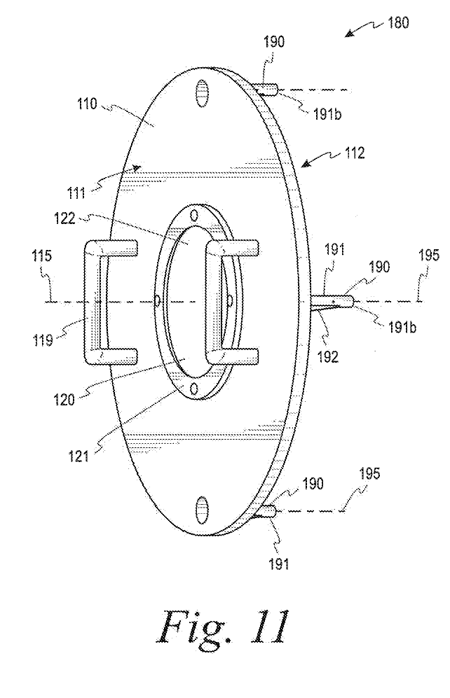

In the embodiment of flange 100 previously described, fasteners 15 used to mount flange 100, and in particular base plate 110, to connection flange 12 of STS cargo transfer line 10 are bolts 15a and associated nuts 15b. However, in other embodiments, different types of fasteners can be employed. For example, referring now to FIG. 11, an embodiment of a flow through flange 180 is shown. Flow through flange 180 is the same as flow through flange 100 previously described except that fasteners 190 are used to removably mount flange 180 to connection flange 12 of STS cargo transfer line 10 instead of fasteners 15 (e.g., bolts 15a and nuts 15b) previously described.

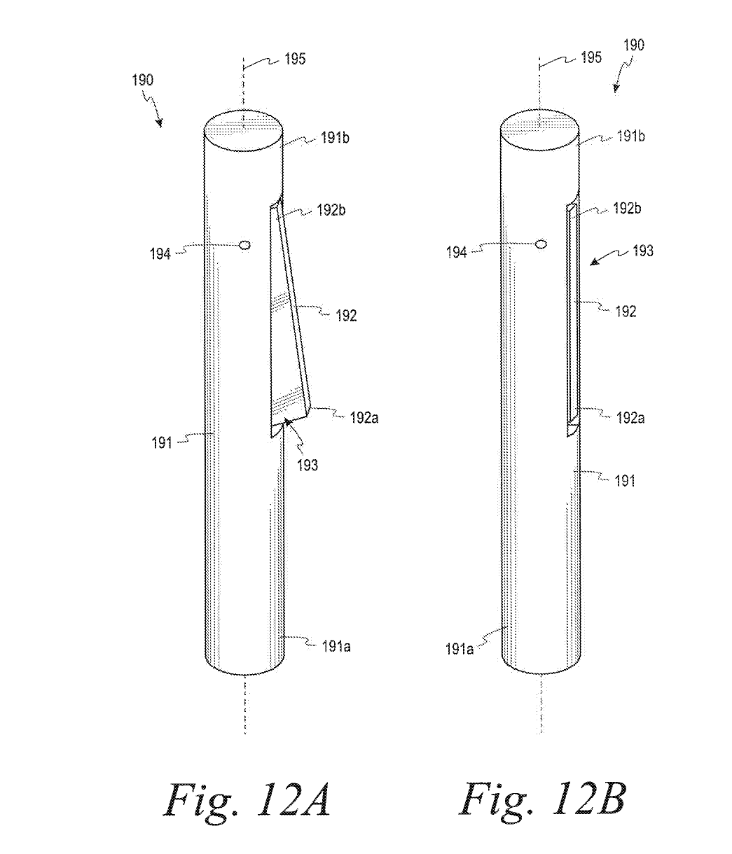

As best shown in FIGS. 12A and 12B, in this embodiment, each fastener 190 is a locking pin including an elongate shaft 191 and a locking member 192 moveably coupled to shaft 191. Shaft 191 has a central axis 195, a first end 191a, and a second end 191b opposite first end 191a. In addition, shaft 191 includes an elongate rectangular slot or recess 193 proximal end 191b. Locking member 192 is slidably disposed in slot 193 and has a first end 192a and a second end 192b, which is pivotally coupled to shaft 191 with a pin 194. Thus, locking member 192 can pivot relative to shaft 191 between an extended position shown in FIG. 12A and a withdrawn position shown in FIG. 12B. In the extended position, end 192a extends radially outward from shaft 191 while end 192b remains disposed within slot 193, whereas in the withdrawn position, locking member 192 is completely disposed within slot 193. A biasing member (not shown) is disposed in slot 193 between shaft 191 and end 192a, thereby biasing locking member 192 to the extended position. However, by applying a sufficiently large radially inward force on end 192a, locking member 192 can be transitioned to the withdrawn position.

Referring again to FIG. 11, end 191a of each fastener 190 is fixably attached to base plate 100 (e.g., threaded into a mating bore, welded, etc.) such that each fastener 190 extends axially from face 112. In particular, fasteners 190 are uniformly circumferentially-spaced and radially positioned such that each fastener 190 can be aligned with one hole 14 in connection flange 12. To mount flange 100 to connection flange 12 with fasteners 190, flange 100 is oriented with face 112 facing connection flange 12 and with each fastener 190 is coaxially aligned with a corresponding hole 14 in connection flange 12. Next, flange 100 is moved axially toward connection flange 12 as each fastener 190 slides through a corresponding bore 14. As fasteners 190 advance through bores 14, locking members 192 transition from the extended positions to the withdrawn positions. However, once locking members 192 have passed completely through bores 14, locking members 192 automatically transition back to the extended positions, thereby preventing locking members 192 from being pulled back through bores 14. Pins 191 and locking members 192 are sized and configured such that base plate 110 is immediately adjacent connection flange 12 and gasket 150 is axially compressed therebetween as locking members 192 pass through bores 14 and transition to the extended positions, thereby releasably locking flange 100 to connection flange 12.

To remove flange 100 from connection flange 12, ship personnel manually urge ends 192a of locking members 192 into slots 193, and simultaneously pull flange 100 axially away from connection flange 12 with handles 119. With locking members 192 in the withdrawn positions, fasteners 190 can be pulled through bores 14 in connection flange 12 to allow removal of flange 100.

In the embodiment of flange 100 described herein, screen 120 and blast plate 130 are both provided. However, depending on the particular application and cargo being drained, in other embodiments, screen 120 or blast plate 130 can be eliminated. It should be appreciated that at least one of screen 120 or blast plate 130 is preferably included to inhibit and/or prevent liquid cargo from exiting the cargo transfer line (e.g., STS cargo transfer line 10). Moreover, although blast plate 130 is moveably coupled to base plate 110 in embodiments described herein, in other embodiments, blast plate 130 is fixably coupled to base plate 110 such that blast plate 130 does not move axially relative to base plate 110. In such embodiments, blast plate 130 is preferably coupled to base plate 110 and positioned at axial distance D₁₁₀₋₁₃₀ previously described.

In general, each component of flow through flange 100, 180 (e.g., base plate 110, screen 120, blast plate 130, etc.) can be made of any material that is durable and suitable for use with the cargo being transferred including, without limitation, metals (e.g., steel, aluminum, bronze, etc.), non-metals (e.g., polymers), and composites (e.g., carbon fiber and epoxy matric composites, etc.). However, in embodiments described herein, flange 100, 180 is preferably sufficiently lightweight to be lifted and manipulated by vessel personnel and sufficiently strong and durable for repeated use with hydrocarbon based cargo liquids. Therefore, in embodiments described herein, each component of flow through flange 100, 180 is preferably made of stainless steel (e.g., 304 stainless steel).

While preferred embodiments have been shown and described, modifications thereof can be made by one skilled in the art without departing from the scope or teachings herein. The embodiments described herein are exemplary only and are not limiting. Many variations and modifications of the systems, apparatus, and processes described herein are possible and are within the scope of the disclosure. For example, the relative dimensions of various parts, the materials from which the various parts are made, and other parameters can be varied. Accordingly, the scope of protection is not limited to the embodiments described herein, but is only limited by the claims that follow, the scope of which shall include all equivalents of the subject matter of the claims. Unless expressly stated otherwise, the steps in a method claim may be performed in any order. The recitation of identifiers such as (a), (b), (c) or (1), (2), (3) before steps in a method claim are not intended to and do not specify a particular order to the steps, but rather are used to simplify subsequent reference to such steps.

What is claimed is:

1. A flange for mounting to an end of a ship-to-ship cargo transfer line for transporting hydrocarbon liquids, the flange comprising:
a base plate including an orifice having a central axis and an outer radius;
a blast plate coupled to the base plate and coaxially aligned with the orifice, wherein the blast plate is axially spaced from the base plate;
wherein the blast plate has an outer radius greater than or equal to the outer radius of the orifice and is configured to impede the flow of the hydrocarbon liquids from the flow line through the orifice, and wherein the blast plate is configured to allow the flow of air into the flow line through orifice.

2. The flange of claim 1, wherein the blast plate is configured to move axially relative to the base plate between an open position axially spaced from the base plate and a closed position axially adjacent the blast plate, wherein the blast plate completely covers the orifice in the closed position.

3. The flange of claim 2, wherein the blast plate sealingly engages the base plate in the closed position.

4. The flange of claim 2, wherein the base plate has a first planar face and a second planar fax axially opposite the first planar face, wherein the orifice extends axially from the first planar face to the second planar face;
wherein the blast plate is moveably coupled to the second planar face of the base plate;
wherein a handle is mounted to the first planar face of the base plate.

5. The flange of claim 2, further comprising:
a screen coupled to the base plate and coaxially aligned with the orifice;
wherein the screen has an outer radius greater than or equal to the outer radius of the orifice and is configured to capture the hydrocarbon liquids passing from the flow line through the orifice, and wherein the screen is configured to allow the flow of air into the flow line through orifice.

6. The flange of claim 5, wherein the screen includes a mesh extending over the orifice, wherein the mesh includes a plurality of openings, wherein each opening has a size between 20 micron and 60 micron.

7. The flange of claim 2, wherein the blast plate is axially spaced from the base plate an axial distance D when the blast plate is in the open position, wherein the axial distance D is between 0.25 in. and 2.0 in.

8. The flange of claim 1, wherein the base plate includes a maximum of four uniformly circumferentially-spaced throughbores configured to mount the base plate to the ship-to-ship cargo transfer line.

9. A system for draining a ship-to-ship cargo transfer line including a flexible hose and a connection flange disposed at an open end of the hose, the system comprising:
a base plate releasably mounted to the connection flange, wherein the base plate includes a first planar face, a second planar face, and an orifice extending from the first planar face to the second planar thee, wherein the orifice has a central axis and an outer radius, and wherein the second planar face is axially adjacent the connection flange and the first planar face is distal the connection flange;
a blast plate coupled to the second planar face of the base plate, wherein the blast plate is coaxially aligned with the orifice and has an outer radius greater than the outer radius of the orifice, and wherein the blast plate is configured to inhibit the flow of the hydrocarbon liquids from the flow line through the orifice and allow the flow of air into the flow line through orifice;
a screen mounted to the first planar face of the base plate and covering the orifice, wherein the screen is configured to allow the flow of air into the flow line through orifice and capture the hydrocarbon liquids that flow from the flow line through the orifice.

10. The system of claim 9, wherein the blast plate is configured to move axially relative to the base plate between an open position axially spaced from the base plate and a closed position axially adjacent the blast plate, wherein the blast plate completely covers the orifice in the closed position.

11. The system of claim 10, wherein the blast plate is axially spaced from the base plate an axial distance D when the blast plate is in the open position, wherein the axial distance D is between 0.25 in. and 2.0 in.

12. The system of claim 9, further comprising a handle is mounted to the first planar face of the base plate, wherein the handle extends to a radius that is greater than an inner radius of the connection flange.

13. The system of claim 12, wherein the screen includes a mesh extending over the orifice, wherein the mesh includes a plurality of openings, wherein each opening has a size between 20 micron and 60 micron.

14. The system of claim 12, wherein the connection flange includes a plurality of circumferentially-spaced throughbores configured to couple the connection flange of the ship-to-ship cargo transfer line to a mating connection flange;
wherein the base plate includes a plurality of circumferentially-spaced throughbores configured to couple the base plate to the connection flange of the ship-to-ship cargo transfer line;
wherein a total number of the throughbores in the base plate is less than a total number of the throughbores in the connection flange of the ship-to-ship cargo transfer line.

15. The system of claim 14, wherein the total number of the throughbores in the base plate is four.

16. The system of claim 9, wherein the hose has a diameter greater than or equal to 6.0 in.

17. A method for draining hydrocarbon liquids in a ship-to-ship cargo transfer line including a flexible hose and a connection flange disposed at an open end of the hose, the method comprising:
(a) connecting a flow through flange to the connection flange, wherein the flow through flange includes:
a base plate including an orifice having a central axis and an outer radius;
a blast plate coupled to the base plate, wherein the blast plate is axially spaced from the base plate and extends radially across the orifice;
(b) lifting the flow through flange and the connection flange after (a);
(c) allowing air to flow into the cargo transfer line through the orifice and around the blast plate;
(d) draining the hydrocarbon liquids from the cargo transfer line during (c); and
(e) inhibiting the flow of hydrocarbon liquids in the cargo transfer line through the orifice with the blast plate during (d).

18. The method of claim 17, further comprising:
inhibiting the flow of hydrocarbon liquids through the orifice with a screen that extends across the orifice and is coupled to the base plate.

19. The method of claim 18, wherein the screen comprises a mesh including a plurality of openings, each opening having a size between 20 micron and 60 micron.

20. The method of claim 18, further comprising:
allowing air to flow into the cargo transfer line through the screen, the orifice, and around the blast plate.

21. The method of claim 18, thither comprising:
impacting the blast plate with the hydrocarbon liquids during (e); and
moving the blast plate axially relative to the base plate to a closed position engaging the base plate in response to the impact.

22. The method of claim 17, further comprising:
lowering the flow through flange and the connection flange after (d);
(g) removing the flow through flange from the cargo transfer line after (f); and
(h) mounting a blind flange to the connection flange after (g).
